(19) United States
(12) Patent Application Publication
(10) Pub. No.: US 2015/0169837 A1
(43) Pub. Date: Jun. 18, 2015

(54) EXTERNALLY POWERED TEST METER FIRMWARE UPGRADE

(71) Applicant: LifeScan Scotland Limited, Inverness-shire (GB)

(72) Inventors: Brian GUTHRIE, Inverness (GB); David ELDER, Inverness (GB)

(73) Assignee: LifeScan Scotland Limited, Inverness-shire (GB)

(21) Appl. No.: 14/133,083

(22) Filed: Dec. 18, 2013

(51) Int. Cl. G06F 19/00; G06F 9/445; G01N 27/26

(52) U.S. Cl. CPC G06F 19/3412; G01N 27/26; G06F 8/65

(57) ABSTRACT

An analyte meter having nonvolatile memory is configured to update its firmware via a USB cable using the power provided by the cable to transfer program code into temporary storage in the meter and to transfer the program code from the temporary storage to a program memory for reprogramming the meter's microcontroller.

### TECHNICAL FIELD

This application generally relates to the field of portable battery-powered blood glucose meters and more specifically to upgrading firmware in a blood glucose meter without using the meter's resident battery.

### BACKGROUND

Hand held blood glucose measurement systems are used for testing an individual's blood in a variety of surroundings at any time of day. These systems typically comprise an analyte meter that is configured to receive a biosensor, usually in the form of a test strip. Because these systems are portable, and testing can be completed in a short amount of time, patients are able to use such devices in the normal course of their daily lives. Therefore, a person with diabetes may measure their blood glucose levels several times a day as a part of a self management process to ensure glycemic control of their blood glucose within a target range.

These types of blood glucose meters are typically powered using a small battery, such as a coin cell, and so are limited in the total power provided by the battery to the electronic sub-system that performs glucose measurements. This power limitation may result in unnecessary premature battery power depletion if the meter's battery is used for performing operations other than blood glucose measurements, such as by performing firmware upgrades.

In the electronic sub-system of the blood glucose meter, the firmware comprises program code stored in nonvolatile memory, such as in EEPROM or in flash memory that is accessible by the meter's microcontroller. This program code is typically the control program of the meter which controls operation of the meter's functions. Firmware upgrades require that new program code be sent to the meter, loaded into the nonvolatile memory, and installed as a replacement for the previous firmware version. This sequence of steps may be referred to as “reprogramming” or “upgrading” the meter. Users are motivated to install upgrades because the newer program code typically comprises improved performance over an existing version or the firmware may provide new or updated operational features.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a diagram of an exemplary test strip based blood analyte measurement system including a test meter and an insertable test strip;

FIG. 1B illustrates a diagram of an exemplary processing system of the test strip based blood analyte measurement system of FIG. 1A; and

FIG. 2 illustrates a flow diagram of a method for upgrading firmware of the meter illustrated in FIG. 1A.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “patient” or “user” refer to any human or animal subject and are not intended to limit the systems or methods to human use, although use of the subject invention in a human patient represents a preferred embodiment.

The term “sample” means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein include blood, plasma, red blood cells, serum and suspension thereof.

The term “about” as used in connection with a numerical value throughout the description and claims denotes an interval of accuracy, familiar and acceptable to a person skilled in the art. The interval governing this term is preferably ±10%. Unless specified, the terms described above are not intended to narrow the scope of the invention as described herein and according to the claims.

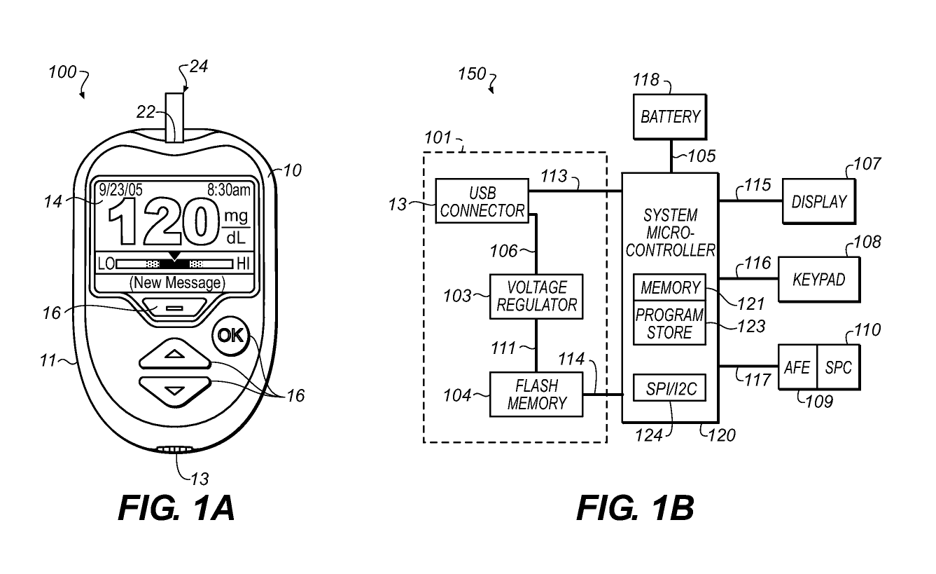

FIG. 1A illustrates an analyte measurement system 100 that includes an analyte meter 10 defined by a housing 11 including a test strip port 22 that is sized and configured for receiving a test strip 24. According to one embodiment, the analyte meter 10 may be a blood glucose meter and the test strip 24 is provided in the form of a blood glucose test strip 24 inserted into the strip port 22 for performing blood glucose measurements. The housing 11 includes a front facing exterior surface that is provided with a plurality of user interface buttons 16 and a display 14. A data/power port 13, such as a USB port, is provided at a bottom side of the housing 11 opposite the test strip port 22. The plurality of user interface buttons 16 may be configured to allow the entry of data, to prompt an output of data, to navigate menus presented on the display 14, and to execute commands. Output data can include values representative of analyte concentration presented on the display 14, such as blood glucose concentration, in units of mg/dL. User inputs may be requested via prompts presented on the display 14 and may result in command execution by a contained data management unit 150, FIG. 1B, or user responses may be stored in a memory module of the analyte meter 10. Specifically and according to this exemplary embodiment, the user interface buttons 16 include markings, e.g., up-down arrows, text characters “OK”, etc, which allow a user to navigate through the user interface presented on the display 14. Although the buttons 16 are shown herein as separate switches, a touch screen interface on display 14 with virtual buttons may also be utilized.

The electronic components of the glucose measurement system 100 can be disposed on, for example, a printed circuit board situated within the housing 11 and forming the data management unit 150 of the herein described system. FIG. 1B illustrates, in simplified schematic form, several of the modules and electronic sub-systems disposed within the housing 11 for purposes of this embodiment. More specifically and according to this exemplary embodiment, the data management unit 150 includes a processing unit 120 in the form of a microprocessor, a microcontroller, an application specific integrated circuit (“ASIC”), a mixed signal processor (“MSP”), a field programmable gate array (“FPGA”), or a combination thereof, and is electrically connected to various electronic modules included on, or connected to, the printed circuit board, as will be described below. The processing unit 120 is electrically connected to, for example, a test strip port connector circuit 110 via an analog front end (“AFE”) sub-system 109 over communication interface 117.

Referring to FIGS. 1A and 1B, the strip port connector circuit 110 is disposed at the test strip port 22 for electrically connecting to an analyte test strip 24, inserted in strip port 22 during blood glucose testing. To measure a selected analyte concentration, the strip port connector circuit 110 detects a resistance or impedance across electrodes of the analyte test strip 24 having a blood sample disposed thereon, using a potentiostat, and converts an electric current measurement into digital form for presentation on the display 14. Under firmware control, the processing unit 120 may be configured to receive input from the strip port connector circuit 110 and may also perform a portion of the potentiostat function and the current measurement function.

The analyte test strip 24 can be in the form of an electrochemical glucose test strip that includes one or more working electrodes. Test strip 24 can also include a plurality of electrical contact pads, where each electrode can be in electrical communication with at least one electrical contact pad. Strip port connector circuit 110 can be configured to electrically interface to the electrical contact pads and form electrical communication with the electrodes. Test strip 24 can include a reagent layer that is disposed over at least one electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose into an enzymatic by-product and in the process generate an amount of reduced mediator (e.g., ferrocyanide) that is proportional to the glucose concentration. The working electrode can then be used to measure a concentration of the reduced mediator in the form of a current magnitude. In turn, the strip port connector circuit 110 can convert the current magnitude into a glucose concentration. An exemplary analyte meter performing such current measurements is described in U.S. Patent Application Publication No. US 2009/0301899 A1 entitled “System and Method for Measuring an Analyte in a Sample”, which is incorporated by reference herein as if fully set forth in this application.

Still referring to FIGS. 1A and 1B, a display module 107, which may include a display processor and display buffer connected to the display 14, is electrically connected to the processing unit 120 over the communication interface 115 for receiving and displaying output data on the display 14, and for displaying user interface input options under control of processing unit 120. The structure of the user interface, such as menu options, is stored in memory 121 accessible by processing unit 120 for presenting menu options to a user of the blood glucose measurement system 100. User input module 108 receives inputs via a user keypad, including buttons 16, which are transmitted to the processing unit 120 over the communication interface 116. The processing unit 120 may have electrical access to a digital time-of-day clock connected to the printed circuit board for recording dates and times of blood glucose measurements, which may then be accessed, uploaded, or displayed at a later time as necessary.

The memory module 121, i.e. on-board memory, includes, but is not limited to, volatile random access memory (“RAM”), a nonvolatile memory, e.g. program store 123, which may comprise read only memory (“ROM”), nonvolatile RAM (“NVRAM”), or flash memory. A USB circuit 101, comprising USB/data port 13, is electrically connected to the processing unit 120 over data/power interface 113, and data interface 114 which may also include a power line, as necessary. External memory devices may be connected to the USB/data port 13 including flash memory devices housed in thumb drives, portable hard disk drives, data cards, or any other form of electronic storage devices. The on-board memory 121 can include various embedded applications, i.e. firmware, executed by the processing unit 120 for operation of the analyte meter 10, as described herein. The on-board memory 121 can also be used to store a history of a user's blood glucose measurements including dates and times associated therewith. Using a wireless transmission capability of the analyte meter 10, or the data port 13, such measurement data can be transferred via wired or wireless transmission to connected computers or other processing devices.

A power supply module 118 is electrically connected to modules 107, 108, 109 of the DMU 150, and to the processing unit 120 over power supply interface 105 to supply electric power thereto. The power supply module 118 may comprise a standard battery, such as a coin cell, or rechargeable batteries that are recharged when the analyte meter 10 is connected to a source of AC power such as through a USB cable at data/power port 13. The power supply module 118 may also be electrically connected to processing unit 120 over a communication interface such that processing unit 120 can monitor a power level remaining in a battery of the power supply module 118.

In addition to connecting external storage for use by the analyte meter 10, the data port 13 can be used to accept a USB connector attached to a cable, thereby allowing the analyte meter 10 to be communicatively connected to an external device such as a personal computer, a data storage device, or any other USB compliant host device. Data/USB port 13 may be capable of receiving a USB connector inserted therein for transmission of data such as the firmware upgrade described herein. The firmware upgrade typically includes improvements and/or new operational features embodied in new program algorithms that are not included in the firmware that is currently resident in the meter 10.

Prior to downloading the firmware upgrade to the blood glucose meter 10, the firmware may be stored on a USB compliant device that is connectible to the blood glucose meter 10 via the data/USB port 13, such as a portable storage device or another processing system, such as a PC. The USB protocol provides that, in addition to data transmission, the USB cable/connector deliver about five volts (5 V) at a current level up to about 500 mA, which is sufficient to provide power to transfer data from a connected USB compliant device to the analyte meter 10 without requiring use of the analyte meter's power supply 118. When a connection is established as between an external device containing updated firmware for upgrading the firmware resident in the program store 123 of the meter 10, the USB provided voltage may be coupled via power interface 106, internal to the meter 10, for powering the flash memory 104, which typically resides in an integrated circuit chip. This power supply is provided to the flash memory 104 via the voltage regulator 103 over the voltage interface 111. The supplied USB power lines, typically provided over a two-wire conductor, enables the flash memory 104 to receive and store the firmware upgrade. In addition, the USB delivered power may be used to transfer the firmware upgrade from its temporary storage in the flash memory 104 to the program storage 123 of the processing unit 120 over the data interface 114 which may also include a power line, as necessary. A common chip-to-chip data transfer interface 124 may be implemented on-board the microcontroller 120, such as a SPI/I²C interface which provides for adequate data transfer speeds.

Electrical connections between the battery, e.g. coin cell, of the power supply 118 and the flash memory 104 are not required, such that the flash memory chip 104 is invisible to, and not accessible by, the microcontroller 120 unless a USB cable is plugged into data/USB port 13 to supply power thereto. This lack of an electrical connection saves several microamps of battery current when the test meter 10 is in a sleep mode, and several milliamps of battery current when the test meter 10 is in an active mode, i.e. performing or displaying a glucose measurement. During transfer of the upgraded firmware into the microcontroller program storage 123, the USB cable remains plugged into the data/USB port 13 and provides power to the components of the USB circuit 101. Thus, the flash memory 104 may be used only when it is powered by a connected USB device.

After the new firmware is transferred to the flash memory 104, whether encrypted or not, it may be checked for integrity, compatibility, version number, and/or decrypted before being finally installed in the microcontroller 120 program storage 123. During the data transfer, the USB cable remains inserted in the test meter's USB/data port 13 to provide power for the flash memory 104. The external power provided by the USB cable is sufficient to power the entire upgrade process. This can be guaranteed at all states of battery charge, and across the full operating temperature range of the test meter 10.

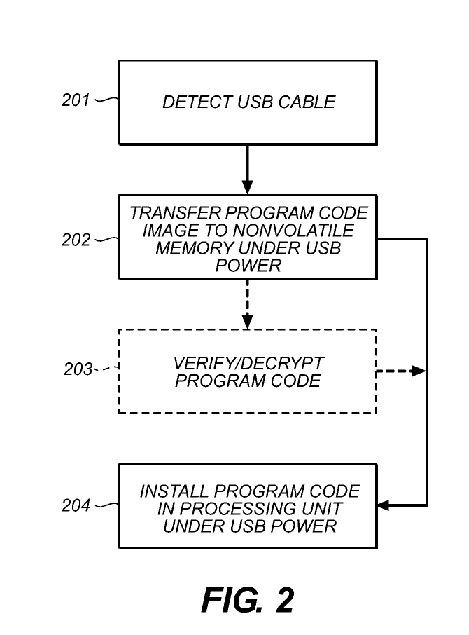

With reference to FIG. 2, there is illustrated a flowchart of a method performed by the meter 10 for upgrading its firmware without requiring use of electrical power from the resident power supply 118. At step 201, an insertion of a USB connector into USB/data port 13 is detected by the processing unit 120. Insertion of the USB connector couples its 5V voltage line to a voltage regulator 103 within the analyte meter 10 and, in turn, provides power to flash memory 104 for receiving and storing therein a firmware upgrade transmitted over the inserted USB cable at step 202. Transmission of the firmware upgrade is initiated by the processing unit 120 sending a signal over data/power interface 113. The power provided by the USB cable is further used for transferring the new control program from the flash memory to the program store 123 in the processing unit 120 at step 204. These steps are performed while the USB cable remains inserted in the USB/data port 13 and provides power to the meter's USB circuitry 101. An alternative step, step 203, that may be performed after the program code is transferred to the flash memory 104 at step 202, is to scan, verify, and/or decrypt the program code while it is stored therein. Scanning the code may be performed for verifying compatibility of the code with the meter 10 hardware, or to detect potential malware, for example. Encrypted or compressed versions of the new program code may also be decrypted or decompressed in combination with this step. Upon loading, or installing, the new program code, using power provided by the USB cable, in the processing unit's program storage 123, at step 304, the upgrade of the meter 10 is complete.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible, non-transitory medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Furthermore, the various methods described herein can be used to generate software codes using off-the-shelf software development tools. The methods, however, may be transformed into other software languages depending on the requirements and the availability of new software languages for coding the methods.

### PARTS LIST FOR FIGS. 1A-2

10 analyte meter
11 housing, meter
13 USB/data port
14 display
16 user interface buttons
22 strip port connector
24 test strip
100 analyte measurement system
101 USB circuit
103 voltage regulator
104 flash memory
105 power interface
106 data/power interface
107 display module
108 buttons/keypad module
109 analog front end
110 strip port connector
111 data/power interface
113 communication interface
111 data/power interface
114 communication (power) interface
115 communication interface
116 communication interface
117 communication interface
118 battery power supply
120 microcontroller (processing unit)
121 memory module
123 program store
124 SPI/12C interface
150 data management unit
201 step, detect USB cable
202 step, transfer code
203 step, verify/decrypt code
204 step, install code

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. An analyte meter comprising:
a microcontroller comprising electronic memory storing resident firmware which, when executed by the microcontroller, causes the microcontroller to perform an analyte measurement;
a power supply electrically connected to the microcontroller for powering the analyte measurement; and
a USB circuit for receiving a USB connector inserted therein, the USB circuit comprising nonvolatile memory that is connected to the electronic memory of the microcontroller, the nonvolatile memory for storing updated firmware transmitted over the USB cable for loading into the electronic memory of the microcontroller, the nonvolatile memory being unconnected to the power supply and operable under electrical power delivered by the inserted USB cable.

2. The analyte meter of claim 1, wherein the power supply comprises a coin cell.

3. The analyte meter of claim 1, wherein the nonvolatile memory comprises flash memory.

4. The analyte meter of claim 1, wherein the updated firmware replaces the resident firmware when the updated firmware is loaded into the microcontroller electronic memory.

5. The analyte meter of claim 3, wherein the flash memory stores the updated firmware transmitted over the USB cable, the electronic memory stores the updated firmware when transferred from the flash memory, and wherein the flash memory and the electronic memory both receive and store the updated firmware under electrical power delivered by the USB cable.

6. The analyte meter of claim 3, wherein the flash memory is unpowered and inaccessible by the microcontroller when the USB cable is removed from the USB circuit.

7. A method of upgrading a resident program in a battery powered analyte meter, the method comprising:
connecting a USB cable to the analyte meter;
transmitting new program code over the USB cable into nonvolatile storage in the meter, including powering the nonvolatile storage using electrical power from the USB cable; and
transferring the new program code from the nonvolatile storage into a microcontroller program memory for programming the microcontroller according to the new program code, the new program code comprising an algorithm for causing the microcontroller to perform an analyte measurement.

8. The method of claim 7, further comprising powering the analyte measurement using a power supply electrically connected to the microcontroller.

9. The method of claim 7, further comprising powering the analyte measurement using a coin cell electrically connected to the microcontroller.

10. The method of claim 7, wherein the step of transmitting new program code comprises transmitting the new program code over the USB cable into a flash memory.

11. The method of claim 10, further comprising replacing the resident program in the microcontroller program memory with the new program code from the flash memory.

12. The method of claim 7, further comprising the flash memory storing the new program code transmitted over the USB cable, the program memory storing the new program code when transferred from the flash memory, and the flash memory and the program memory both receiving electric power transmitted by the USB cable.

13. The method of claim 12, further comprising depowering the flash memory each time the USB cable is removed from the analyte meter.

14. The method of claim 9, further comprising performing the analyte measurement under program control of the new program code and under power from the coin cell.

15. An analyte meter comprising:
a microcontroller having program storage comprising a resident control program for controlling operation of the analyte meter when the resident control program is executed;
a memory chip connected to the program storage and comprising a new control program, the memory chip configured to transfer the new control program into the program storage to replace the resident control program; and
a USB circuit connected to the memory chip for storing therein the new control program when the new control program is received over the USB circuit, the USB circuit receiving electrical power from a USB cable connected to the USB circuit for powering the memory chip and for powering the transfer of the new control program from the memory chip into the program storage.

16. The analyte meter of claim 15, further comprising a power supply electrically connected to the microcontroller for powering an analyte measurement performed by the microcontroller.

17. The analyte meter of claim 16, wherein the memory chip comprises flash memory and the power supply comprises a coin cell.

18. The analyte meter of claim 17, wherein the flash memory is inaccessible by the microcontroller when the USB cable is removed from the USB circuit.

19. The analyte meter of claim 17, wherein the new control program includes an algorithm for performing operational features that are not provided by the resident program when executed by the microcontroller.

20. The analyte meter of claim 19, wherein the microcontroller executes the algorithm for performing the operational features under power provided by the coin cell.

21. A method for updating firmware of a hand-held test meter, the method comprising:
powering a flash memory integrated circuit of a hand-held test meter via a USB connector of the hand-held test meter;
downloading updated firmware to the flash memory integrated circuit via the USB connector; and
updating firmware stored in a microcontroller of the hand-held test meter with the updated firmware stored in the flash memory integrated circuit.
